(19) United States
(12) Patent Application Publication
(10) Pub. No.: US 2026/0010580 A1
(43) Pub. Date: Jan. 8, 2026

(54) MICRO CONTROLLER UNIT, METHOD OF DETECTING SIGNAL, AND COMMUNICATION DEVICE

(71) Applicant: Samsung Electronics Co., Ltd., Suwon-si (KR)

(72) Inventors: Changhwan YI, Suwon-si (KR); Ikhwan KIM, Suwon-si (KR); Jungwoo KIM, Suwon-si (KR); Seungbae HAN, Suwon-si (KR)

(73) Assignee: Samsung Electronics Co., Ltd., Suwon-si (KR)

(21) Appl. No.: 19/007,958

(22) Filed: Jan. 2, 2025

(30) Foreign Application Priority Data
Jul. 5, 2024 (KR) 10-2024-0088893

(51) Int. Cl. G06F 17/14; G06F 17/16

(52) U.S. Cl. CPC G06F 17/142; G06F 17/16

(57) ABSTRACT

A micro controller unit including: a memory configured to store first data and second data, the first data being represented in a floating point form, and the second data being obtained by sampling a signal, and processing circuitry configured to generate (1_1)-th data by right-shifting the first data by a first bit, generate a difference between the first data and the (1_1)-th data to obtain (1_2)-th data, and perform 1-point discrete Fourier transform on the (1_1)-th data, the (1_2)-th data, and the second data based on a first function.

### CROSS-REFERENCE TO RELATED APPLICATION

This application claims priority to, and the benefit of, Korean Patent Application No. 10-2024-0088893 filed in the Korean Intellectual Property Office on Jul. 5, 2024, the entire contents of which are incorporated herein by reference.

### BACKGROUND

### (a) Technical Field

The present disclosure relates to a micro controller unit (MCU), and a method of detecting a signal and a communication device that utilize the same.

### (b) Description of the Related Art

During the production process of radio frequency integrated circuit (RFIC) chips, the RFIC chips are generally tested through an electrical die sorting (EDS) process using equipment such as automatic test equipment (ATE). However, the above process involves excessive delay.

To reduce the time involved in the EDS process, a method of performing tests through embedded built in self test (BIST) logic is also being used. The embedded BIST logic may sample signals from the transmitter and perform discrete Fourier transform (DFT) on the sampled data.

### SUMMARY

An embodiment relates to a micro controller unit, a method of detecting a signal, and a communication device that may perform a 1-point DFT computation even on data lost as data in which a signal is sampled is shifted.

An embodiment provides a micro controller unit including: a memory configured to store first data and second data, the first data being represented in a floating point form, and the second data being obtained by sampling a signal, and processing circuitry configured to generate (1_1)-th data by right-shifting the first data by a first bit, generate a difference between the first data and the (1_1)-th data to obtain (1_2)-th data, and perform 1-point discrete Fourier transform on the (1_1)-th data, the (1_2)-th data, and the second data based on a first function.

An embodiment provides a method of detecting a signal, including: receiving a signal, acquiring sampling data by sampling the signal, acquiring first frequency data based on a frequency of the signal and a number of the sampling data, the first frequency data being represented in a floating point form, generating second frequency data by right-shifting the first frequency data by a first bit, generating a difference between the first frequency data and the second frequency data to obtain third frequency data, and performing 1-point discrete Fourier transform on the second frequency data, the third frequency data, and the sampling data based on a first function.

An embodiment provides a communication device including: a transmission circuit, a reception circuit, a loop-back switch configured to selectively enable a built in self test mode, the built in self test mode including transmission of a signal from the transmission circuit to the reception circuit, and processing circuitry configured to receive the signal from the reception circuit to test the signal, sample the signal to acquire sampling data, acquire first frequency data based on a frequency of the signal and a number of the sampling data, the first frequency data being represented in a floating point form, generate second frequency data by right-shifting the first frequency data by a first bit, generate a difference between the first frequency data and the second frequency data to obtain third frequency data, and perform 1-point discrete Fourier transform on the second frequency data, the third frequency data, and the sampling data based on a first function.

### BRIEF DESCRIPTION OF THE DRAWINGS

FIG. 1 illustrates a block diagram of a wireless communication device according to an embodiment of the present disclosure.

FIG. 2 illustrates a block diagram of a signal processing process of a digital transmission processing unit shown in FIG. 1.

FIG. 3 illustrates a block diagram of a wireless communication device according to an embodiment of the present disclosure.

FIG. 4 illustrates a block diagram for explaining a communication device according to an embodiment of present disclosure.

FIG. 5 illustrates a block diagram for explaining a micro controller unit according to an embodiment of present disclosure.

FIG. 6 is a drawing for explaining the Goertzel algorithm.

FIG. 7 is a drawing for explaining the Goertzel algorithm.

FIG. 8 is a drawing for explaining a data structure according to a position of a floating point.

FIG. 9 is a drawing for explaining a data computation according to a position of a floating point.

FIG. 10 is a drawing for explaining a data computation method of a micro controller unit according to an embodiment of the present disclosure.

FIG. 11 is a drawing for explaining a data computation method of a micro controller unit according to an embodiment of the present disclosure.

FIG. 12 is a drawing for explaining a data computation method of a micro controller unit according to an embodiment of the present disclosure.

FIG. 13 is a drawing for explaining a data computation method of a micro controller unit according to an embodiment of the present disclosure.

FIG. 14 is a drawing for explaining a data computation method of a micro controller unit according to an embodiment of the present disclosure.

FIG. 15 is a drawing for explaining a data computation method of a micro controller unit according to an embodiment of the present disclosure.

FIG. 16 is a drawing for explaining a data computation method of a micro controller unit according to an embodiment of the present disclosure.

FIG. 17 is a drawing for explaining a data computation method of a micro controller unit according to an embodiment of the present disclosure.

FIG. 18 illustrates a flowchart of a signal detection method according to an embodiment of the present disclosure.

FIG. 19 illustrates a block diagram of an Internet of Things (IoT) device to which a wireless communication device according to an embodiment of the present disclosure is applied.

FIG. 20 illustrates a block diagram of a mobile terminal to which a wireless communication device according to an embodiment of the present disclosure is applied.

### DETAILED DESCRIPTION

The present disclosure will be described more fully hereinafter with reference to the accompanying drawings, in which embodiment(s) of the disclosure are shown. As those skilled in the art would realize, embodiment(s) may be modified in various different ways, all without departing from the spirit or scope of the present disclosure.

Accordingly, the drawings and description are to be regarded as illustrative in nature and not restrictive. Like reference numerals designate like elements throughout the specification. In the flowcharts described with reference to the drawings in this specification, the operation order may be changed, various operations may be merged, certain operations may be divided, and certain operations may not be performed.

In addition, a singular form may be intended to include a plural form as well, unless an explicit expression such as “one” or “single” is used. Terms including ordinal numbers such as first, second, and the like will be used only to describe various constituent elements, and are not to be interpreted as limiting these constituent elements. These terms may be used for a purpose of distinguishing one constituent element from other constituent elements.

Hereinafter, the present disclosure will be described in more detail through examples. These examples are merely for illustrating the present disclosure, and the scope of rights protection of the present disclosure is not limited by these examples.

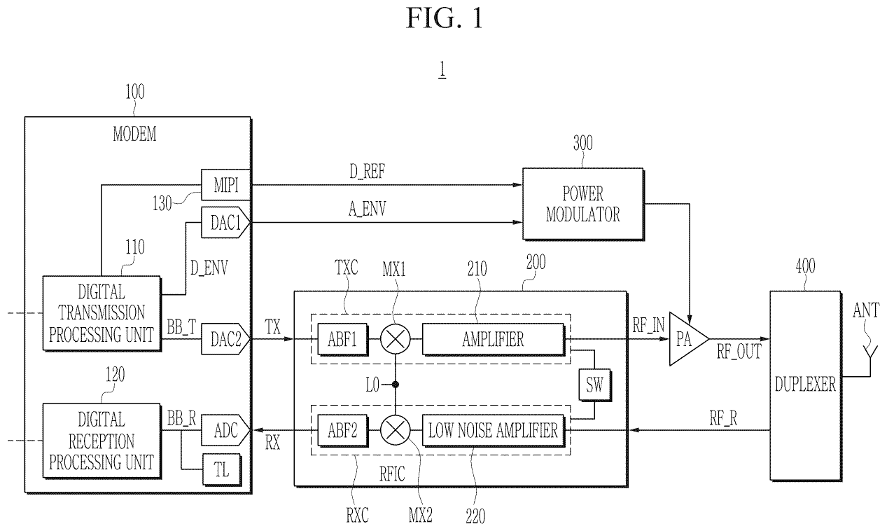

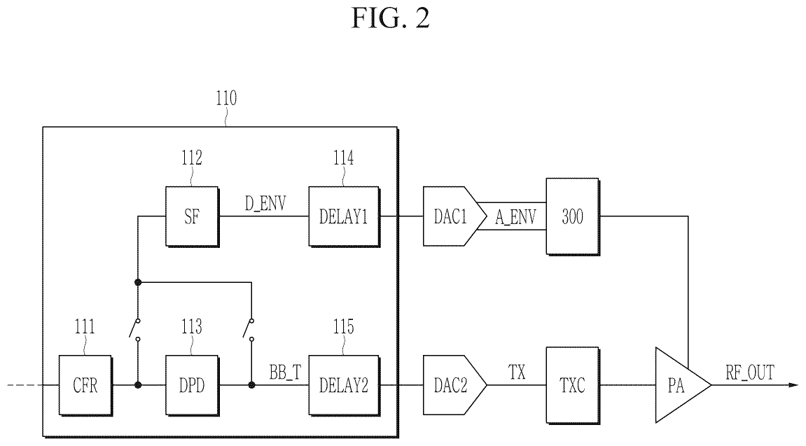

FIG. 1 illustrates a block diagram of a wireless communication device according to an embodiment of the present disclosure. FIG. 2 illustrates a block diagram of a signal processing process of a digital transmission processing unit shown in FIG. 1.

Referring to FIG. 1, a wireless communication device 1 according to an embodiment of the present disclosure may include a modem 100, a radio frequency integrated circuit (RFIC) 200, a power modulator 300, a duplexer 400, a power amplifier PA, and/or an antenna ANT.

The modem 100 may include a digital transmission processing unit 110, a digital reception processing unit 120, a plurality of digital to analog converters DAC1 and DAC2, an analog to digital converter (ADC), and/or a mobile industry processor interface (MIPI) 130.

The modem 100 may process a baseband signal BB_T (for example, including an I signal and a Q signal) including information to be transmitted through the digital transmission processing unit 110 according to a predetermined (or alternatively, given) communication method. In addition, the modem 100 may process the received baseband signal BB_R according to a predetermined (or alternatively, given) communication method through the digital reception processing unit 120. For example, the modem 100 may process a signal to be transmitted or a signal received, according to communication methods such as orthogonal frequency division multiplexing (OFDM), orthogonal frequency division multiple access (OFDMA), wideband code division multiple access (WCDMA), high speed packet access+ (HSPA+), etc. In addition, the modem 100 may process the baseband signal BB_T or BB_R according to various types of communication methods (that is, various communication methods to which a technology for modulating or demodulating the amplitude and frequency of the baseband signal BB_T or BB_R is applied).

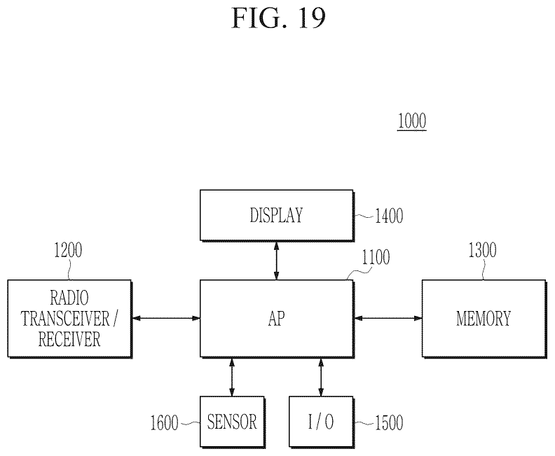

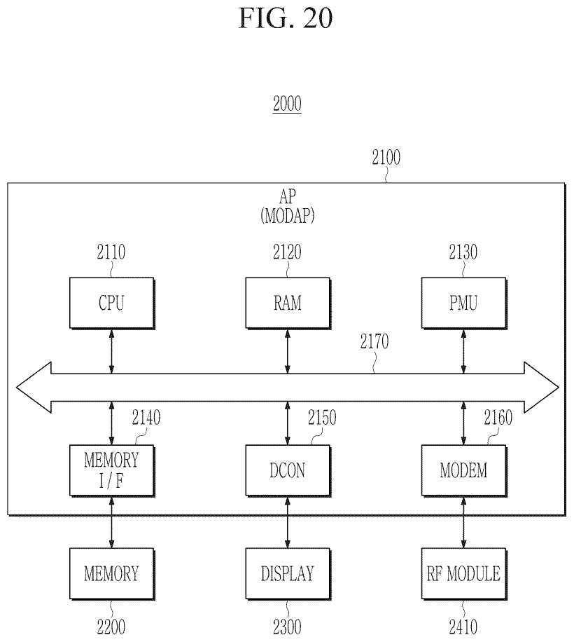

The modem 100 may extract an envelope of the baseband signal BB_T through the digital transmission processing unit 110 and generate a digital envelope signal D_ENV based on the extracted envelope. In addition, the modem 100 may generate an average power signal D_REF based on an average power tracking table (that is, APT table) stored in a memory (for example, 1300 in FIG. 19 or 2200 in FIG. 20). Here, the extracted envelope may correspond to the amplitude component (that is, the magnitude of the I signal and the Q signal) of the baseband signal BB_T.

In addition, the APT table stores the required (or otherwise, used) power voltage information of the power amplifier PA according to the expected output power (or transmission power) of the antenna ANT, and the average power signal information corresponding to the required (or otherwise indicated, demanded, etc.) power voltage of the power amplifier PA. Accordingly, when the expected output power of the antenna ANT is determined, the modem 100 may generate the average power signal D_REF using the APT table and provide the generated average power signal D_REF to the power modulator 300 as a reference voltage signal.

Here, referring to FIG. 2, a detailed signal processing process of the digital transmission processing unit 110 is illustrated.

Specifically, the digital transmission processing unit 110 may perform various tasks through crest factor reduction (CFR) 111, shaping function (SF) 112, digital pre-distortion (DPD) 113, DELAY1 (114), DELAY2 (115), and the like, in addition to the above-described baseband signal processing, envelope extraction, and digital envelope signal generation.

The CFR 111 may reduce the peak-to-average power ratio (PAPR) of a communication signal (for example, the baseband signal BB_T). In addition, the SF 112 may transform a digital envelope signal D_ENV to improve the efficiency and linearity of the power amplifier PA, and the DPD 113 may linearize the distortion of the power amplifier PA by compensating for it in the digital area. In addition, the DELAY1 114 may correct a delay of the digital envelope signal D_ENV, and the DELAY2 115 may correct a delay of the baseband signal BB_T.

The digital transmission processing unit 110 having this configuration may output the digital envelope signal D_ENV and the baseband signal BB_T. In addition, the digital envelope signal D_ENV may be converted into an analog envelope signal A_ENV through a first digital to analog converter DAC1 and provided to the power modulator 300, and the baseband signal BB_T may be converted into a transmission signal TX through a second digital to analog converter DAC2 and provided to a transmission circuit TXC.

Although not shown in the drawing, the digital transmission processing unit 110 may further include an internal configuration that processes the above-described tasks (that is, baseband signal processing, envelope extraction, digital envelope signal generation, and the like). In addition, the internal configuration of the digital transmission processing unit 110 shown in FIG. 2 is only an example embodiment, and is not limited thereto.

Referring back to FIG. 1, the modem 100 may respectively perform digital/analog conversion for the baseband signal BB_T and the digital envelope signal D_ENV using a plurality of digital to analog converters DAC1 and DAC2 provided therein to generate the transmit signal TX and the analog envelope signal A_ENV, which are analog signals. In addition, the average power signal D_REF outputted from the modem 100 may be a digital signal. Accordingly, the average power signal D_REF may be provided to a digital to analog converter provided in the power modulator 300 through the MIPI 130, and may be converted into an analog signal, for example, a reference voltage signal through a digital to analog converter provided in the power modulator 300. For reference, the digital to analog converters DAC1 and DAC2 provided in the modem 100 may operate at a relatively higher speed than the digital to analog converter provided in the power modulator 300.

However, the present disclosure is not limited thereto, and the modem 100 may convert the average power signal D_REF into an analog signal through a digital to analog converter provided therein to output it. In this case, the modem 100 may provide the average power signal converted into an analog signal to the power modulator 300 as a reference voltage signal.

However, for better understanding and ease of description, in the present disclosure, it will be described as an example that the modem 100 provides the average power signal D_REF through the MIPI 130 to a digital to analog converter provided in the power modulator 300.

For reference, the transmission signal TX and the analog envelope signal A_ENV may be differential signals including positive and negative signals, respectively.

In addition, the modem 100 may receive a reception signal RX, which is an analog signal, from the RFIC 200. In addition, the modem 100 may extract the baseband signal BB_R, which is a digital signal, by converting the reception signal RX from analog to digital through the analog to digital converter ADC provided therein. Here, the reception signal RX may be a differential signal including a positive signal and a negative signal.

The RFIC 200 may generate the RF input signal RF_IN by performing frequency up-conversion on the transmission signal TX or may generate the reception signal RX by performing frequency down-conversion on the RF reception signal RF_R. Specifically, the RFIC 200 may include a transmission circuit TXC for frequency up-conversion, a reception circuit RXC for frequency down-conversion, and/or a local oscillator LO.

Here, the transmission circuit TXC may include a first analog baseband filter ABF1, a first mixer MX1, and/or an amplifier 210. For example, the first analog baseband filter ABF1 may include a low pass filter.

The baseband filter ABF1 may filter the transmission signal TX received from the modem 100 to provide it to the first mixer MX1. In addition, the first mixer MX1 may perform frequency up-conversion to convert the frequency of the transmission signal TX from the base band to the higher frequency band (e.g., radio frequency (RF) band) through the frequency signal provided by the local oscillator LO. Through this frequency up-conversion, the transmission signal TX may be provided to the amplifier 210 as the RF input signal RF_IN, and the amplifier 210 may primarily power-amplify (or perform a first power-amplification on) the RF input signal RF_IN to provide it to the power amplifier PA.

The power amplifier PA may be supplied with a power voltage (that is, a dynamically variable output voltage) from the power modulator 300. The power amplifier PA may secondarily amplify the power (or perform a second power-amplification) of the RF input signal RF_IN based on the supplied power voltage and generate the RF output signal RF_OUT. The power amplifier PA may provide the generated RF output signal RF_OUT to the duplexer 400.

The reception circuit RXC may include a second analog baseband filter ABF2, a second mixer MX2, and/or a low-noise amplifier 220. For example, the second analog baseband filter ABF2 may include a low pass filter.

The low noise amplifier 220 may amplify the RF reception signal RF_R provided from the duplexer 400 to provide it to the second mixer MX2. In addition, the second mixer MX2 may perform frequency down-conversion to convert the frequency of the reception signal RF_R from the higher frequency band (e.g., radio frequency (RF) band) to the base band through the frequency signal provided by the local oscillator LO. Through this frequency down-conversion, the RF reception signal RF_R may be provided as a reception signal RX to the second analog baseband filter ABF2, and the second analog baseband filter ABF2 may filter the reception signal RX to provide it to the modem 100.

For reference, the wireless communication device 1 may transmit a transmission signal through a plurality of frequency bands using carrier aggregation (CA) technology. To this end, the wireless communication device 1 may include a plurality of power amplifiers that power-amplify a plurality of RF input signals RF_IN respectively corresponding to a plurality of carriers. However, in the present disclosure, for better understanding and ease of description, it will be described using one electric power amplifier (PA) as an example.

The power modulator 300 may generate a modulated output voltage whose level changes dynamically based on the analog envelope signal A_ENV and the average power signal D_REF to provide the modulated output voltage to the power amplifier PA as a power voltage.

Specifically, the power modulator 300 may be provided with the average power signal D_REF and the analog envelope signal A_ENV from the modem 100. In addition, based on the provided average power signal D_REF and analog envelope signal A_ENV, the power modulator 300 may be driven in one of the tracking modes of envelope tracking (ET) mode and/or average power tracking (APT) mode to generate a dynamically variable output voltage. In addition, the power modulator 300 may supply the generated output voltage to the power amplifier PA as a power voltage.

For reference, when a fixed level power voltage is applied to the power amplifier PA, the power efficiency of the power amplifier PA decreases. Therefore, for efficient power management of the power amplifier PA, the power modulator 300 may modulate the input voltage (that is, power provided from the battery) based on at least one of the analog envelope signal A_ENV and the average power signal D_REF, and may provide the modulated voltage to the power amplifier PA as a power voltage.

The duplexer 400 may be connected to the antenna ANT to separate the transmission frequency and the reception frequency. Specifically, the duplexer 400 may separate the RF output signal RF_OUT provided from the power amplifier PA for each frequency band to provide it to the corresponding antenna ANT. In addition, the duplexer 400 may provide an external signal provided from the antenna ANT to the low noise amplifier 220 of the reception circuit RXC of the RFIC 200. For example, the duplexer 400 may include a front end module with integrated duplexer (FEMiD).

For reference, instead of the duplexer 400, the wireless communication device 1 may be provided with a switch structure capable of separating the transmission frequency and the reception frequency. In addition, the wireless communication device 1 may be provided with a structure configured of the duplexer 400 and a switch to separate the transmission frequency and the reception frequency. However, for better understanding and ease of description, in the present disclosure, it will be described as an example that the duplexer 400 capable of separating the transmission frequency and the reception frequency is provided in the wireless communication device 1.

The antenna ANT may transmit the RF output signal RF_OUT frequency-separated by the duplexer 400 to the outside or provide the RF reception signal RF_R received from the outside to the duplexer 400. For example, the antenna ANT may include an array antenna, but is not limited thereto.

For reference, the modem 100, the power modulator 300, the RFIC 200, the power amplifier PA, and/or the duplexer 400 may be individually implemented as an IC, chip, or module. In addition, the modem 100, the power modulator 300, the RFIC 200, the power amplifier PA, and/or the duplexer 400 may be mounted together on a printed circuit board (PCB). However, the technical idea of the present disclosure is not limited thereto, and in an embodiment, at least some of the modem 100, the power modulator 300, the RFIC 200, the power amplifier PA, and/or the duplexer 400 may be implemented as a single communication chip.

Furthermore, the wireless communication device 1 shown in FIG. 1 may be included in a wireless communication system using a cellular network such as 5G or LTE, or may be included in a wireless local area network (WLAN) system or any other wireless communication system. For reference, the configuration of the wireless communication device 1 shown in FIG. 1 is only an embodiment, and is not limited thereto, and may be variously configured according to a communication protocol or a communication method.

In an embodiment, the wireless communication device 1 may perform BIST. The wireless communication device 1 may test whether the transmission circuit TXC and/or the reception circuit RXC are operating normally.

In an embodiment, the RFIC 200 may include a loop-back switch SW. The loop-back switch SW may be connected between the transmission circuit TXC and the reception circuit RXC. A signal outputted from the transmission circuit TXC may be transmitted (e.g., directly transmitted) to the reception circuit RXC through the loop-back switch SW.

In an embodiment, the modem 100 may include a test logic TL, and the test logic TL may perform a computation on a signal transmitted to the reception circuit RXC through the loop-back switch SW. For example, the test logic TL may perform a 1-point discrete Fourier transform on the transmitted signal.

The test logic TL may store sampling data that samples the transmitted signal and floating point data corresponding to a specific frequency, and perform 1-point discrete Fourier transform on shifted data generated by right-shifting the floating point data by a predetermined (or alternatively, given) bit (e.g., a bit position, and/or quantity of bits or bit digits), difference data between the shifted data and the floating point data, and the sampling data, based on the Goertzel algorithm.

That is, the test logic TL may perform a computation of dividing floating point data representing a relatively large value into shifted data and difference data, and multiplying the divided shifted data and difference data with sampling data, respectively.

The test logic TL may include a memory of a predetermined (or alternatively, given) bit that stores result data of the computation. When a value obtained by multiplying floating point data representing a relatively large value and sampling data exceeds the number of bits of the memory, overflow may occur. According to an embodiment, since the right shifted shifting data is multiplied by the sampling data, the occurrence of overflow may be prevented or reduced. According to an embodiment, since the difference data is multiplied by the sampling data, a 1-point DFT computation may be performed even on a smaller value of floating point data.

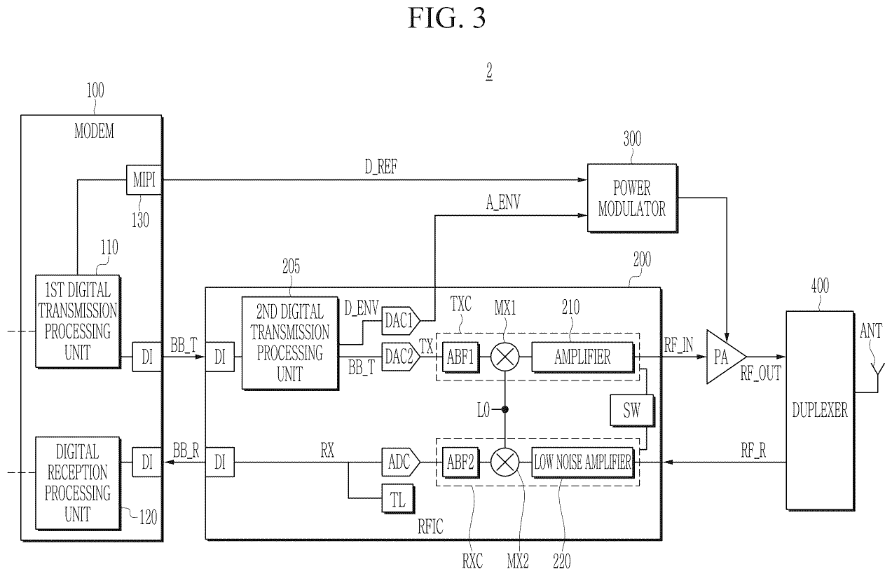

FIG. 3 illustrates a block diagram of a wireless communication device according to an embodiment of the present disclosure.

A wireless communication device 2 has the same configuration, function, and effect as (or a similar configuration, function, and effect to) the wireless communication device 1 in FIG. 1 except for the contents related to the analog envelope signal A_ENV, so differences will be mainly described.

Referring to FIG. 3, the wireless communication device 2 according to an embodiment of the present disclosure may include a modem 100, an RFIC 200, a power modulator 300, a duplexer 400, a power amplifier PA, and/or an antenna ANT.

The modem 100 may process the baseband signal BB_T through the internal first digital transmission processing unit 110 according to a predetermined (or alternatively, given) communication method. In addition, the modem 100 may provide the processed baseband signal BB_T to the RFIC 200 through a digital interface DI. In addition, the modem 100 may extract an envelope of the baseband signal BB_T through the first digital transmission processing unit 110 and generate an average power signal D_REF based on the extracted envelope.

Here, the average power signal D_REF may be provided to the power modulator 300 as a reference voltage signal. That is, the average power signal D_REF outputted from the modem 100 may be a digital signal. Accordingly, the average power signal D_REF may be provided to a digital to analog converter provided in the power modulator 300 through the MIPI 130, and may be converted into an analog signal, for example, a reference voltage signal through the digital to analog converter provided in the power modulator 300. For reference, digital to analog converters DAC1 and DAC2 provided in the RFIC 200 may operate at a relatively higher speed than the digital to analog converter provided in the power modulator 300.

The RFIC 200 may receive the baseband signal BB_T from the modem 100 through the digital interface DI. The RFIC 200 may extract an envelope of the baseband signal BB_T through an internal second digital transmission processing unit 205 and generate a digital envelope signal D_ENV based on the extracted envelope.

The RFIC 200 may perform digital/analog conversion for the baseband signal BB_T and the digital envelope signal D_ENV using a plurality of digital to analog converters DAC1 and DAC2 to generate the transmit signal TX and the analog envelope signal A_ENV, which are analog signals. In addition, the RFIC 200 may generate the RF input signal RF_IN by performing frequency up-conversion on the transmission signal TX through the transmission circuit TXC, and may provide the analog envelope signal A_ENV to the power modulator 300.

In addition, the wireless communication device 2 may perform BIST, and the RFIC 200 may include a loop-back switch SW and a test logic TL for performing BIST. Unlike FIG. 1, in FIG. 3, the test logic TL is included in the RFIC 200, and detailed contents related thereto are the same as (or similar to) those described in FIG. 1, so they will be omitted below.

The power modulator 300 may generate a modulated voltage, the level of which changes dynamically based on the analog envelope signal A_ENV and the average power signal D_REF, to provide the modulated voltage to the power amplifier PA as a power voltage.

Specifically, the power modulator 300 may be provided with the average power signal D_REF from the modem 100 and the analog envelope signal A_ENV from the RFIC 200. In addition, based on the provided average power signal D_REF and analog envelope signal A_ENV, the power modulator 300 may be driven in one of the tracking modes of ET mode and/or APT mode to generate a dynamically variable output voltage. In addition, the power modulator 300 may supply the generated output voltage to the power amplifier PA as a power voltage.

Here, the power modulator 300 may be provided with the analog envelope signal A_ENV from the modem 100 when driving in the ET mode, and may be provided with the average power signal D_REF from the modem 100 when updating the average power signal in an internal register (not shown).

For reference, the configuration of the wireless communication device 2 shown in FIG. 3 is an embodiment, is not limited thereto, and may be variously configured according to a communication protocol or a communication method.

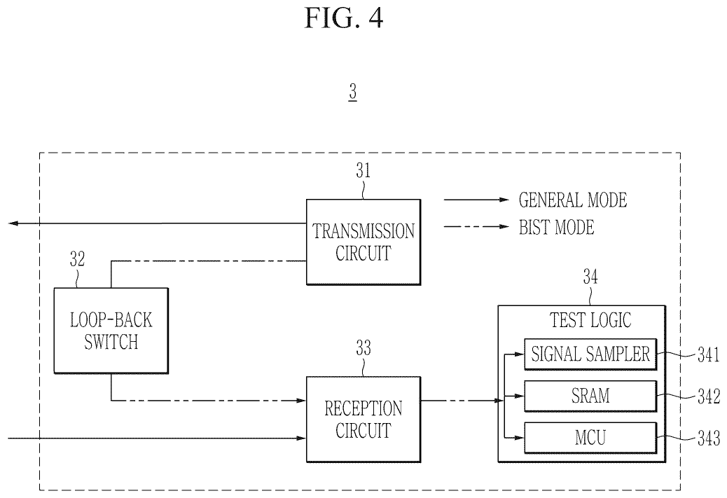

FIG. 4 illustrates a block diagram for explaining a communication device according to an embodiment of present disclosure.

Referring to FIG. 4, a communication device 3 may include a transmission circuit 31, a loop-back switch 32, a reception circuit 33, and/or test logic 34.

The transmission circuit 31 may include various configurations to output a signal. For example, the transmission circuit 31 may include a digital to analog converter DAC for digital/analog conversion of the generated signal, a local oscillators for frequency up-conversion of a signal, a drive amplifier (or power amplifier) for amplifying a signal, and/or an antenna for outputting a signal to the outside, and the above components may perform operations substantially similar to respective corresponding components (e.g., the transmission circuit TXC) described in FIG. 1 to FIG. 3.

The reception circuit 33 may include various components for receiving a signal. For example, the reception circuit 33 may include an antenna for receiving a signal, a low-noise amplifier for amplifying the received signal, a local oscillator for frequency down-conversion of a signal, and/or an analog to digital converter (ADC) for analog/digital conversion of a signal, and the above components may perform operations substantially similar to respective corresponding components (e.g., the reception circuit RXC) described in FIG. 1 to FIG. 3.

The loop-back switch 32 may have substantially the same configuration as the loop-back switch SW shown in FIG. 1 and FIG. 3, and may transmit a signal outputted from the transmission circuit 31 to the reception circuit 33 when turned on. Specifically, when the communication device 3 operates in the BIST mode, the loop-back switch 32 may be turned on (e.g., may be closed) to transmit (e.g., directly transmit) the signal from the transmission circuit 31 to the reception circuit 33, the reception circuit 33 may provide the transmitted signal to the test logic 34, and the test logic 34 may perform computations on the signal. When the communication device 3 operates in a normal mode, the loop-back switch 32 may be turned off (e.g., may be opened), and accordingly, the transmission circuit 31 may output a signal to the outside (e.g., outside of the communication device 3), and the reception circuit 33 may receive a signal from the outside. According to an embodiment, the loop-back switch 32 may be turned on/off in response to a signal from processing circuitry (e.g., from the micro control unit 343 and/or the CPU 2110 discussed below). According to an embodiment, the loop-back switch 32 may selectively enable the BIST mode when the loop-back switch 32 is turned on.

The test logic 34 may have substantially the same configuration as the test logic TL shown in FIG. 1 and FIG. 3, and may include a signal sampler 341, an SRAM 342, and/or a micro controller unit 343.

The signal sampler 341 may sample the signal provided from the reception circuit 33. The signal sampler 341 may sample the signal based on the control of the micro controller unit 343, for example, the signal sampler 341 may be controlled to sample the signal at a signal sampling clock frequency of 245.76 MHz to obtain 4096 sampling data (e.g., 4096 bits of sampling data).

The SRAM 342 may receive and store data on a 1-point discrete Fourier transform, and information on a computation method such as a computation order and a function. According to an embodiment, the above-described operation may be implemented with DRAM rather than the SRAM 342. Data on the 1-point discrete Fourier transform and information on the computation method may be provided in the form of OTP, but are not necessarily limited thereto.

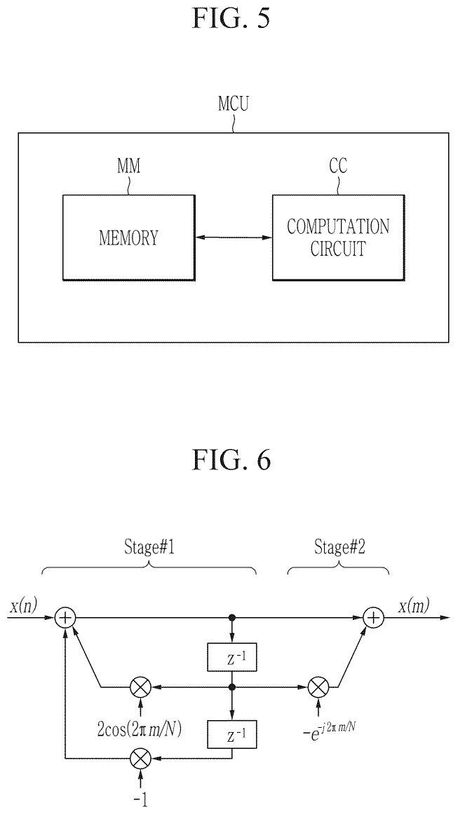

The micro controller unit 343 may perform computations on the received signal and test the signal, based on the data and computation method on the 1-point discrete Fourier transform provided in the SRAM 342. Specific details are described in FIG. 5 and below.

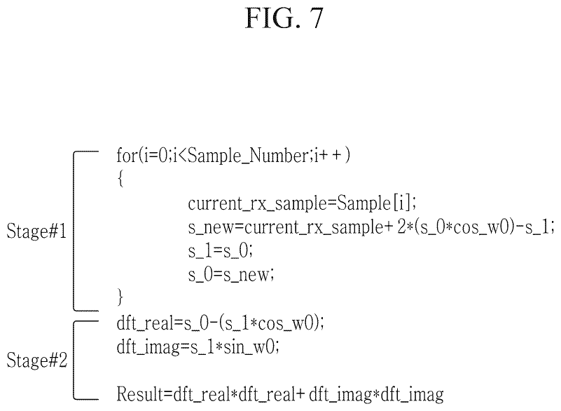

FIG. 5 illustrates a block diagram for explaining a micro controller unit according to an embodiment of present disclosure, and FIG. 6 and FIG. 7 is a drawing for explaining the Goertzel algorithm.

Referring to FIG. 5, a micro controller unit MCU may include a memory MM and/or a computation circuit CC. The micro controller unit MCU shown in FIG. 5 may have substantially the same configuration as the micro controller unit 343 shown in FIG. 4.

The memory MM may store data necessary (or otherwise, used) to perform a computation on a signal. For example, the memory MM may store data obtained by sampling a signal, data determined based on the frequency of the signal and the number of sampling data. The memory MM may include, for example, a plurality of 32-bit registers, but is not necessarily limited thereto.

The computation circuit CC may perform 1-point discrete Fourier transform on data stored in the memory MM based on a predetermined (or alternatively, given) function. Here, the predetermined (or alternatively, given) function may be a Goertzel algorithm, but is not necessarily limited thereto.

Specifically, referring to FIG. 6 and FIG. 7, the Goertzel algorithm may proceed in a first stage (Stage #1) and a second stage (Stage #2). The first stage (Stage #1) may be repeated as many times as the number (or quantity) of sampled data. As described above, the number of sampled data may be 4096, but is not necessarily limited thereto.

In the first stage (Stage #1), initial values of s_0 and s_1 may be set to 0. For example, in the case of i=0, s_new may be set to s_0 as the value of Sample [0], and then in the case of i=1, the value set to s_0 in i=0 may be multiplied by the value of cos_w0. According to an embodiment, i may be an integer having a value or 0 or greater. Here, the value of w0 may be calculated by Equation 1 below.

$$w 0 = \frac{2 π * k}{N} \qquad ( Equation 1 )$$

Here, N may mean the number (or quantity) of data (e.g., a number of bits) obtained by sampling the signal, and k may be defined as Equation 2 below.

$$k = \frac{Frequency of Signal}{Resolution Bandwidth} = \frac{Frequency of Signal}{MCU Clock / N} \qquad ( Equation 2 )$$

As described above, the communication device according to an embodiment of the present disclosure may sample signals at a frequency of the clock of the micro controller unit MCU (e.g., 245.76 MHz) when BIST is performed, the number of sampling data may be 4096 (e.g., 4096 bits), and the frequency of the signal (e.g., the signal being sampled) may be 1020 kHz. The value of cos_w0 may be calculated as in Equation 3 below based on the above value.

$$cos\_w0 = cos ( \frac{2 π * \frac{1020 kHz}{245.76 MHz / 4096}}{4096} ) = 0.999659997 \qquad ( Equation 3 )$$

The values of the signal sampling clock frequency, signal frequency, and number of sampled data described above are only example values for better understanding and ease of description, and are not necessarily limited thereto. According to an embodiment, the Goertzel algorithm may be performed using methods and/or implementations known to a person of ordinary skill in the art, and modified as discussed herein.

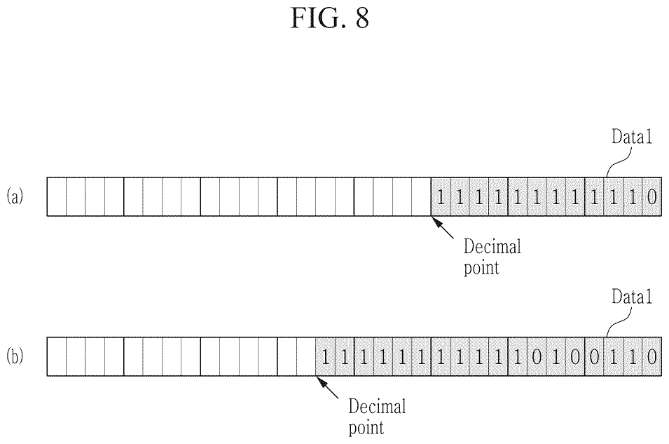

FIG. 8 is a drawing for explaining a data structure according to a position of a floating point.

Referring to FIG. 8, a first data (Data1) may have a size of 32-bit so that it may be stored in the plurality of 32-bit registers of the memory MM shown in FIG. 5, and its value may be represented in the form of a floating point. Here, the first data (Data1) may mean the value of cos_w0 described with reference to FIG. 6 and FIG. 7. That is, returning to FIG. 8, the value of 0.999659997₍₁₀₎, which is the value of cos_w0 described with reference to FIG. 6 and FIG. 7, is converted into a binary value of 0.111 1111 1111 0100 1101 1011 1101 1000₍₂₎, and represents the binary value differently depending on the position of the floating point.

Specifically, (a) represents the first data (Data1) when the bit digit (fxp) of the floating point (Decimal point) is 12, and the first data (Data1) in (a) may have a value of 1111 1111 1110₍₂₎ of 12 digits among the numbers below the decimal point of the value of cos_w0 described above.

(b) represents the first data (Data1) when the bit digit of the floating point is 18, and the first data (Data1) in (b) may have a value of 11 1111 1111 1010 0110₍₂₎ of 18 digits among the numbers below the decimal point of the value of cos_w0 described above.

As shown in (a) and (b) in FIG. 8, the larger the bit digit of the floating point, the greater the number of digits represented below the decimal point, so the accuracy of the data may be improved.

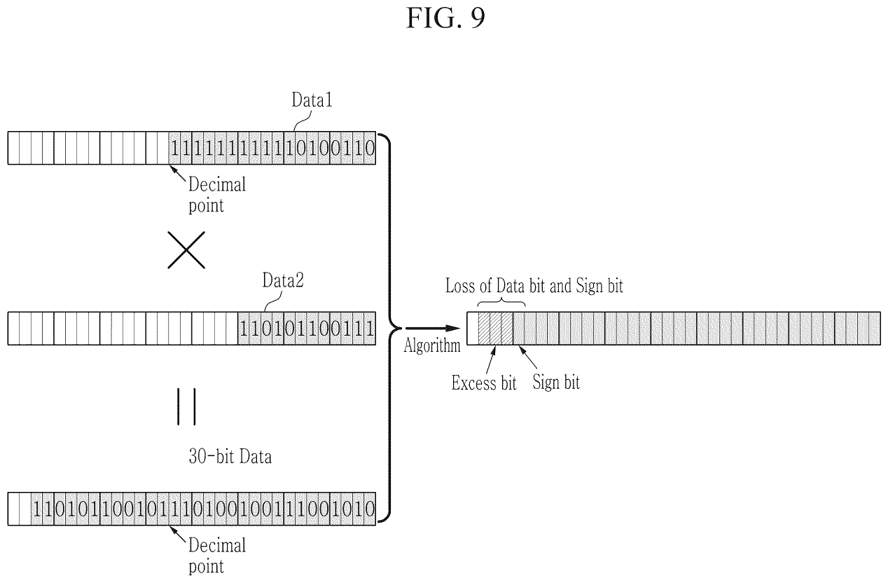

FIG. 9 is a drawing for explaining a data computation according to a position of a floating point.

Referring to FIG. 9, a computation performed on the first data (Data1) may include a computation of multiplying the first data (Data1) and the second data (Data2). Here, the second data (Data2) may refer to data obtained by sampling a signal as described with reference to FIG. 6 and FIG. 7.

As illustrated in FIG. 9, for example, when the first data (Data1) is represented in the form of fxp=18 for accuracy (that is, (b) in FIG. 8) and the second data (Data2) has a 12-bit size of 1101 0110 0111₍₂₎, the product of the first data (Data1) and the second data (Data2) may have a value of 11 0101 1001 0111 0100 1001 1100 1010₍₂₎, and the size thereof may be 30-bit.

As described with reference to FIG. 6 and FIG. 7, the output value calculated based on the value of the product of the first data (Data1) and the second data (Data2) may be inputted as z−1 (that is, s_0 in FIG. 7) of the next iteration and be multiplied again with the first data (Data1) (that is, cos_w0). Accordingly, repetition of this algorithm may cause data overflow, resulting in loss of the sign bit corresponding to the most significant bit (MSB) and some data bits.

An embodiment of the present disclosure provides the micro controller unit capable of dividing the value of the first data (Data1) into data expressing a relatively large value and data expressing a relatively small value, and performing a 1-point DFT computation on each of the divided data, thereby improving the accuracy of data and preventing (or reducing) overflow that may occur when performing a 1-point DFT computation.

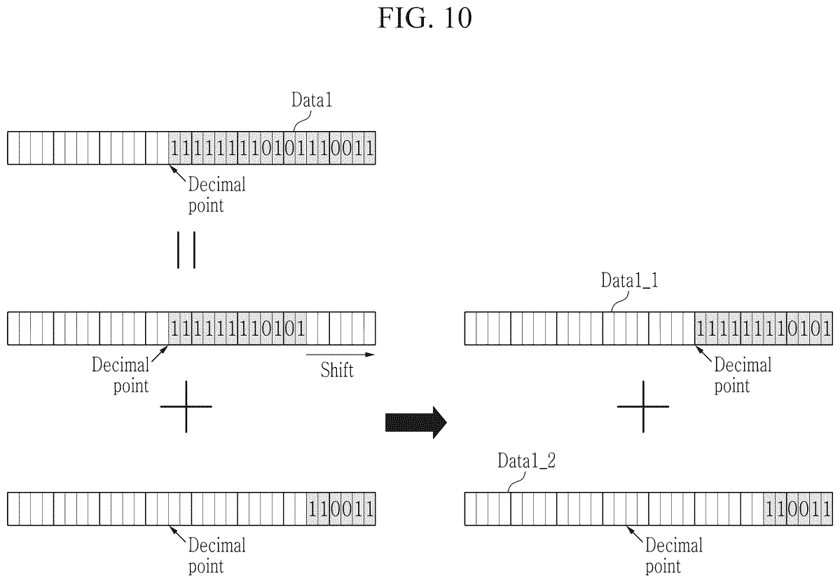

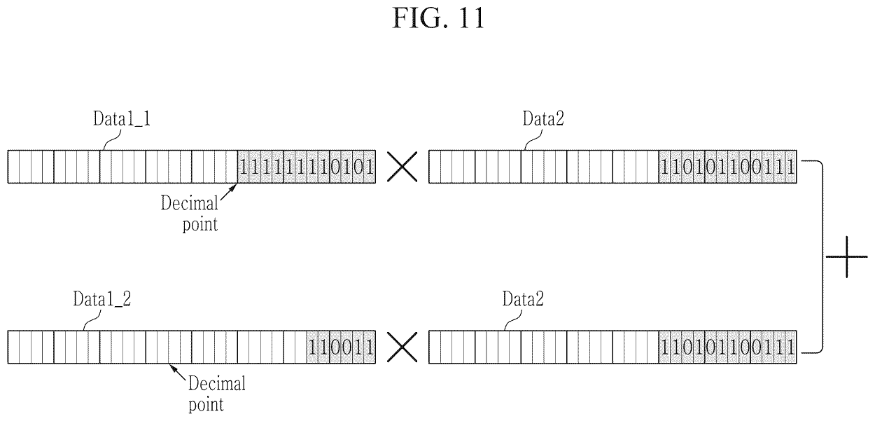

FIG. 10 is a drawing for explaining a data computation method of a micro controller unit according to an embodiment of the present disclosure.

Referring to FIG. 10, the micro controller unit may divide the first data (Data1) into (1_1)-th data (Data1_1) and (1_2)-th data (Data1_2). Specifically, the micro controller unit may generate the (1_1)-th data (Data1_1) by right-shifting the first data (Data1) by a first bit (e.g., a first bit position, and/or first quantity of bits or bit digits), and may generate the difference between the first data (Data1) and the (1_1)-th data (Data1_1) as the (1_2)-th data (Data1_2).

For example, when the first data (Data1) has a value of 11 1111 1101 0111 0011₍₂₎ in the form of fxp=18, the micro controller unit may right-shift the first data (Data1) by 6-bit to generate the (1_1)-th data (Data1_1) represented as 1111 1111 0101₍₂₎, and may generate 11 0011₍₂₎, which is a difference between the first data (Data1) and the (1_1)-th data (Data1_1), as the (1_2)-th data.

As the first data (Data1) is right-shifted by 6-bit, the fxp of the (1_1)-th data (Data1_1) may have a value of 12, while the fxp of the (1_2)-th data (Data_2) may have a value of 18, the same as (or similar to) the first data (Data1).

FIG. 11 is a drawing for explaining a data computation method of a micro controller unit according to an embodiment of the present disclosure.

Referring to FIG. 11, the computation method according to an embodiment of the present disclosure may include multiplying the (1_1)-th data (Data1_1) and the second data (Data2), multiplying the (1_2)-th data (Data1_2) and the second data (Data2), and adding the product value of the (1_1)-th data (Data1_1) and the second data (Data2) to the product value of the (1_2)-th data (Data1_2) and the second data (Data2).

Unlike the case shown in FIG. 9, the micro controller unit performing the computation method according to an embodiment of the present disclosure may perform an computation of multiplying the (1_1)-th data (Data1_1) represented by 12-bit and the second data (Data2) represented by 12-bit, and since the result value of the computation may be represented by 24-bit, overflow may be prevented or reduced when performing the 1-point DFT computation.

In addition, the micro controller unit performing the computation method according to an embodiment of the present disclosure may improve data and computation accuracy by reflecting the small value of the first data (Data1) in the 1-point DFT computation, by performing a computation to multiply the (1_2)-th data (Data1_2) and the second data (Data2).

For better understanding and ease of description, it is described as an example that the first data (Data1) is right-shifted by 6-bit and the second data (Data2) has a 12-bit size of 1101 0110 0111₍₂₎, but are not necessarily limited thereto, and the micro controller unit may right-shift the first data (Data1) to a size other than 6-bit, and the second data (Data2) may also be represented as data having a size other than 12-bit.

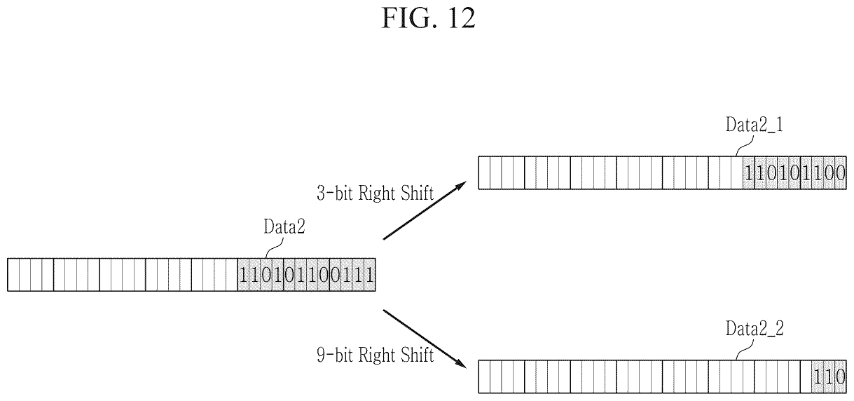

FIG. 12 is a drawing for explaining a data computation method of a micro controller unit according to an embodiment of the present disclosure.

Referring to FIG. 12, the micro controller unit may divide the second data (Data2) into (2_1)-th data (Data2_1) and (2_2)-th data (Data2_2). Specifically, the micro controller unit may generate the (2_1)-th data (Data2_1) by right-shifting the second data (Data2) by a second bit (e.g., a second bit position, and/or second quantity of bits or bit digits), and generate the (2_2)-th data (Data2_2) by right-shifting the second data (Data2) by a third bit (e.g., a third bit position, and/or third quantity of bits or bit digits).

For example, when the second data (Data2) has a value of 1101 0110 0111₍₂₎ in a 12-bit size, the micro controller unit may right-shift the second data (Data2) by 3-bit to generate the (2_1)-th data (Data2_1) represented as 1 1010 1100₍₂₎, and may right-shift the second data (Data2) by 9-bit to generate the (2_2)-th data (Data2_2) represented as 110₍₂₎.

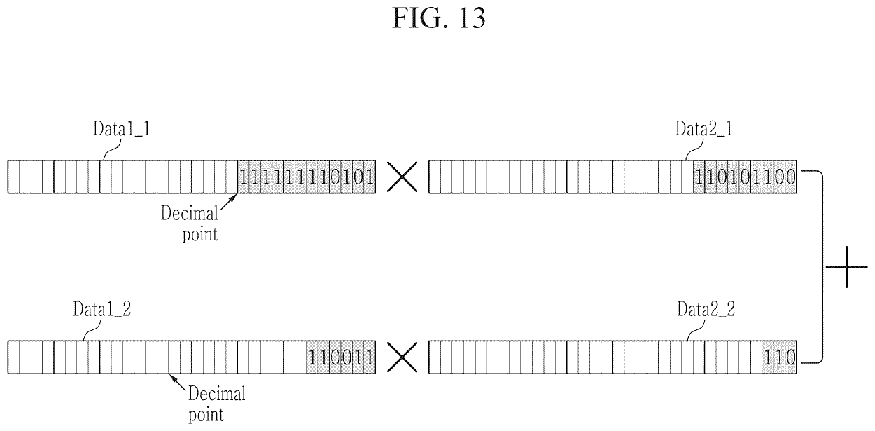

FIG. 13 is a drawing for explaining a computation method of a micro controller unit according to an embodiment of the present disclosure.

Referring to FIG. 13, the computation method according to an embodiment of the present disclosure may include multiplying the (1_1)-th data (Data1_1) and the (2_1)-th data (Data2_1), multiplying the (1_2)-th data (Data1_2) and the (2_2)-th data (Data2_2), and adding the product value of the (1_1)-th data (Data1_1) and the (2_1)-th data (Data2_1) to the product value of the (1_2)-th data (Data1_2) and the (2_2)-th data (Data2_2).

Specifically, the micro controller unit performing the computation method according to an embodiment of the present disclosure multiplies the (1_1)-th data (Data1_1), which represents a relatively large value among the values of the first data (Data1), by the (2_1) data (Data1_2) obtained by right-shifting the second data (Data2) by a relatively small bit, and multiplies the (1_2)-th data (Data1_2), which represents a relatively small value among the values of the first data (Data1), by the (2_2) data (Data2_2) obtained by right-shifting the second data (Data2) by a relatively large bit, so that even if the size of the second data (Data2) is larger, higher computation accuracy may be maintained and overflow may be prevented (or reduced).

In addition, so that the result values of the first data (Data1) and the second data (Data2) and the digits based on a floating point match, the computation method according to an embodiment of the present disclosure may further include shifting the product value of the (1_1)-th data (Data1_1) and the (2_1)-th data (Data2_1) and the product value of the (1_2)-th data (Data1_2) and the (2_2)-th data (Data2_2) by a specific bit. The computation (e.g., the shifting of the product values) may be performed before adding the product value of the (1_1)-th data (Data1_1) and the (2_1)-th data (Data2_1) to the product value of the (1_2)-th data (Data1_2) and the (2_2)-th data (Data2_2).

In addition, so that the digits match, the difference between the bit digits of the floating point of the (1_1)-th data and the second bit for generating the (2_1)-th data (Data2_1) may be the same as (or similar to) the difference between the bit digits of the floating point of the (1_2)-th data and the third bit for generating the (2_2)-th data (Data2_2). That is, the difference between the bit digits of the floating point of the (1_1)-th data and the floating point of the (1_2)-th data may be the same as (or similar to) the difference between the second bit and the third bit.

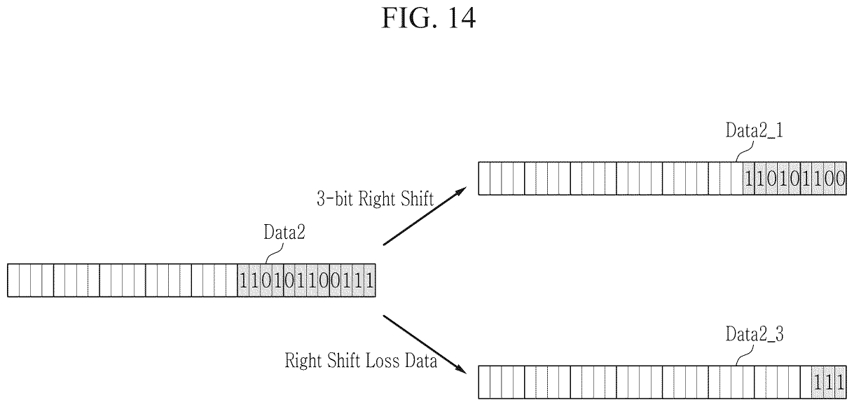

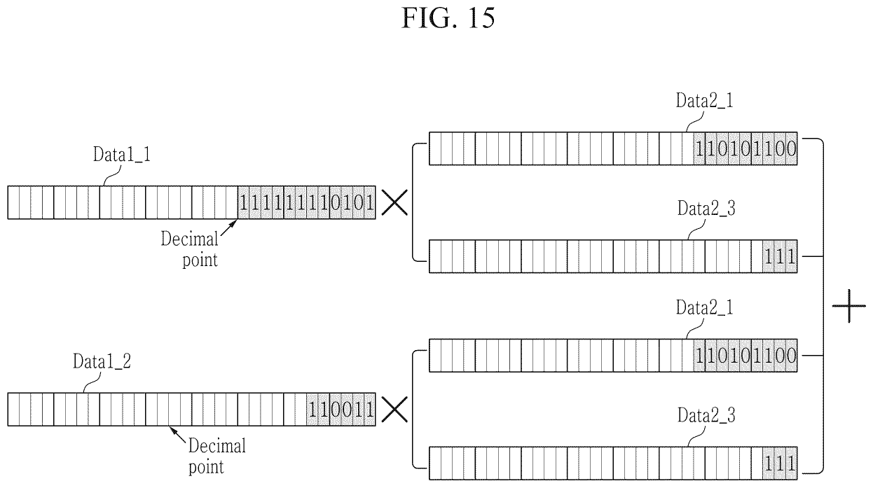

FIG. 14 is a drawing for explaining a data computation method of a micro controller unit according to an embodiment of the present disclosure.

Referring to FIG. 14, the micro controller unit may divide the second data (Data2) into (2_1)-th data (Data2_1) and (2_3)-th data (Data2_3). Specifically, the micro controller unit may generate the (2_1)-th data (Data2_1) by right-shifting the second data (Data2) by the second bit (e.g., the second bit position, and/or second quantity of bits or bit digits), and generate the lost data as the (2_3)-th data (Data2_3) by right-shifting the second data by the second bit. According to an embodiment, the micro controller unit may generate the lost data as the (2_3)-th data (Data2_3) to include the data (e.g., least significant bits) omitted from the second data (Data2) by right-shifting the second data (Data2) by the second bit (e.g., data lost from among the second data (Data2) based on the right-shifting the second data (Data2) by the second bit).

For example, when the second data (Data2) has a value of 1101 0110 0111₍₂₎ in a 12-bit size, the micro controller unit may right-shift the second data (Data2) by 3-bit to generate the (2_1)-th data (Data2_1) represented as 1 1010 1100₍₂₎, and may right-shift the second data (Data2) by 3-bit to generate the lost data, that is, the (2_3)-th data (Data2_3) represented as 111 (2).

FIG. 15 is a drawing for explaining a data computation method of a micro controller unit according to an embodiment of the present disclosure.

Referring to FIG. 15, the computation method according to an embodiment of the present disclosure may include multiplying the (1_1)-th data (Data1_1) and the (2_1)-th data (Data2_1), multiplying the (1_1)-th data (Data1_1) and the (2_3)-th data (Data2_3), multiplying the (1_2)-th data (Data1_2) and the (2_1)-th data (Data2_1), and multiplying the (1_2)-th data (Data1_2) and the (2_3)-th data (Data2_3).

Specifically, the micro controller unit performing the computation method according to an embodiment of the present disclosure may improve the computation accuracy by further performing not only the computation of multiplying each of the (1_1)-th data (Data1_1) and the (1_2)-th data (Data1_2) by the (2_1)-th data (Data2_1) generated by right-shifting the second data (Data2) and but also the computation of multiplying it by the (2_3)-th data (Data2_3) that is data lost by right-shifting.

So that the digits match, the computation method according to an embodiment of the present disclosure may further include shifting each of the product value of the (1_1)-th data (Data1_1) and the (2_1)-th data (Data2_1), the product value of the (1_1)-th data (Data1_1) and the (2_3)-th data (Data2_3), the product value of the (1_2)-th data (Data1_2) and the (2_1)-th data (Data2_1), and the product value of the (1_2)-th data (Data1_2) and the (2_3)-th data (Data2_3) by a specific bit.

The computation method may then further include summing the values of (all of) the respective shifted products.

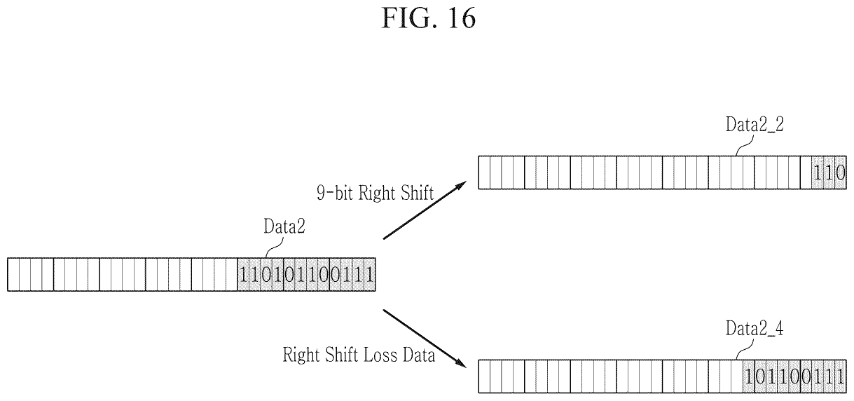

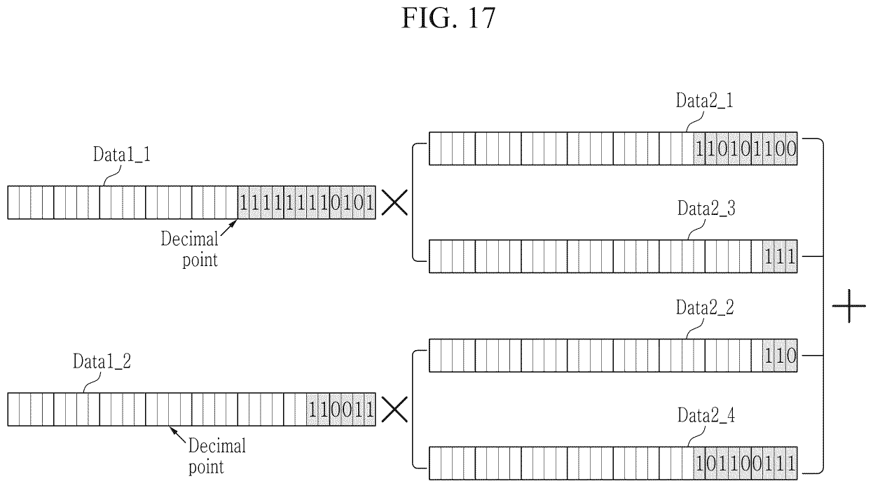

FIG. 16 is a drawing for explaining a data computation method of a micro controller unit according to an embodiment of the present disclosure.

Referring to FIG. 16, the micro controller unit may divide the second data (Data2) into the (2_2)-th data (Data2_2) and the (2_4)-th data (Data2_4). Specifically, the micro controller unit may generate the (2_2)-th data (Data2_2) by right-shifting the second data (Data2) by the third bit (e.g., the third bit position, and/or third quantity of bits or bit digits), and generate the lost data as the (2_4)-th data (Data2_4) by right-shifting the second data by the third bit. According to an embodiment, the micro controller unit may generate the lost data as the (2_4)-th data (Data2_4) to include the data (e.g., least significant bits) omitted from the second data (Data2) by right-shifting the second data (Data2) by the third bit (e.g., data lost from among the second data (Data2) based on the right-shifting the second data (Data2) by the third bit).

For example, when the second data (Data2) has a value of 1101 0110 0111₍₂₎ in a 12-bit size, the micro controller unit may right-shift the second data (Data2) by 9-bit to generate the (2_2)-th data (Data2_2) represented as 110 (2), and may right-shift the second data (Data2) by 9-bit to generate the lost data, that is, the (2_4)-th data (Data2_4) represented as 1 0110 0111₍₂₎.

FIG. 17 is a drawing for explaining a data computation method of a micro controller unit according to an embodiment of the present disclosure.

Referring to FIG. 17, the computation method according to an embodiment of the present disclosure may include multiplying the (1_1)-th data (Data1_1) and the (2_1)-th data (Data2_1), multiplying the (1_1)-th data (Data1_1) and the (2_3)-th data (Data2_3), multiplying the (1_2)-th data (Data1_2) and the (2_2)-th data (Data2_2), and multiplying the (1_2)-th data (Data1_2) and the (2_4)-th data (Data2_4).

Specifically, the micro controller unit performing the computation method according to an embodiment of the present disclosure may improve computation accuracy by further performing a computation of multiplying the (1_1)-th data (Data1_1) by the (2_1)-th data (Data2_1) generated by right-shifting the second bit and the (2_3)-th data (Data2_3), which is data lost by right-shifting, and a computation of multiplying the (1_2)-th data (Data1_2) by the (2_2)-th data (Data2_2) generated by right-shifting by the third bit and the (2_4)-th data (Data2_4), which is data lost by right-shifting.

So that the digits match, the computation method according to an embodiment of the present disclosure may further include shifting each of the product value of the (1_1)-th data (Data1_1) and the (2_1)-th data (Data2_1), the product value of the (1_1)-th data (Data1_1) and the (2_3)-th data (Data2_3), the product value of the (1_2)-th data (Data1_2) and the (2_2)-th data (Data2_2), and the product value of the (1_2)-th data (Data1_2) and the (2_4)-th data (Data2_4) by a specific bit

The computation method may then further include summing the values of (all of) the respective shifted products.

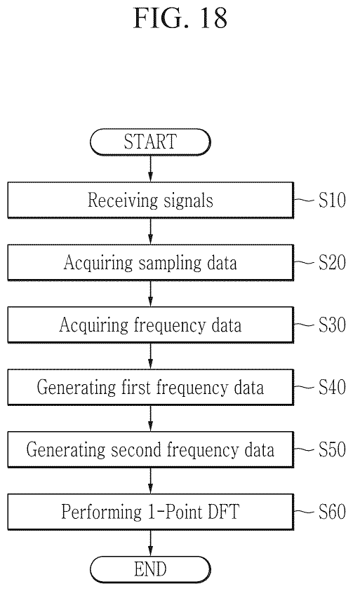

FIG. 18 illustrates a flowchart of a signal detection method according to an embodiment of the present disclosure.

Referring to FIG. 18, the signal detection method may include receiving signals (S10). For example, when the communication device 3 shown in FIG. 4 operates in the BIST mode, the signal outputted from the transmission circuit 31 may be transmitted to the loop-back switch 32, and the reception circuit 33 may receive the signal from the loop-back switch 32.

The signal detection method may include acquiring sampling data by sampling a signal (S20). For example, the signal sampler 341 shown in FIG. 4 may acquire sampling data by sampling the signal received from the transmission circuit 31.

The signal detection method may include acquiring frequency data represented in floating point form based on the frequency of the signal and the number of sampling data (S30). For example, the micro controller unit MCU shown in FIG. 5 may compute and acquire frequency data based on Equation 1 and Equation 2 described above.

The signal detection method may include generating first frequency data by right-shifting the frequency data by a first bit (S40). For example, the micro controller unit MCU shown in FIG. 5 may generate the first frequency data by right-shifting the frequency data based on the computation described with reference to FIG. 10.

The signal detection method may include generating a difference between the frequency data and the first frequency data as second frequency data (S50). For example, the micro controller unit MCU shown in FIG. 5 may generate the difference between the frequency data and the first frequency data obtained by right-shifting it as the second frequency data, based on the computation described with reference to FIG. 10.

The signal detection method may include performing 1-point discrete Fourier transform on the first frequency data, the second frequency data, and the sampling data, based on a predetermined (or alternatively, given) function (S60). For example, the micro controller unit MCU shown in FIG. 5 may perform 1-point discrete Fourier transform on the first frequency data, the second frequency data, and the sampling data based on the Goertzel algorithm. According to an embodiment, the micro controller unit MCU (and/or the CPU 2110 discussed below) may adjust one or more parameters of the RFIC 200 (and/or the RFIC 200) based on a result of the 1-point discrete Fourier transform. As noted above, the 1-point discrete Fourier transform may be used to perform a BIST of the RFIC 200 (and/or the RFIC 200). Using the result of the 1-point discrete Fourier transform, the micro controller unit MCU (and/or the CPU 2110 discussed below) may adjust one or more among the gain of the amplifier 210, the gain of the low noise amplifier 220, and/or any other parameter used during the operations performed by the RFIC 200 (and/or the RFIC 200). According to an embodiment, after the adjustment of the one or more parameters of the RFIC 200 (and/or the RFIC 200), the wireless communication device 1 (and/or the wireless communication device 2, the communication device 3, the mobile terminal 2000, etc.) may perform network communication with an external device (e.g., another wireless communication device 1, a base station, etc.). For example, the wireless communication device 1 (and/or the wireless communication device 2, the communication device 3, the mobile terminal 2000, etc.) may generate a first signal, process the first signal to perform one or more among modulating, upconverting, filtering, amplifying and/or encrypting on the first signal (including, for example, the operations discussed in connection with FIGS. 1-3), and transmit the processed first signal to the external device via one or more antennas ANT. Additionally or alternatively, the wireless communication device 1 (and/or the wireless communication device 2, the communication device 3, the mobile terminal 2000, etc.) may receive a second signal from the external device via the one or more antennas ANT, process the second signal to perform one or more among demodulating, downconverting, filtering, amplifying and/or decrypting on the second signal (including, for example, the operations discussed in connection with FIGS. 1-3), and perform a further operation(s) based on the processed second signal. For example, the further operation(s) may include one or more of providing the processed second signal to a corresponding application executing on the wireless communication device 1 (and/or the wireless communication device 2, the communication device 3, the mobile terminal 2000, etc.), storing the processed second signal, sending a response signal to the external device (e.g., based on a processing result of the corresponding application executing on the wireless communication device 1 and/or the wireless communication device 2, the communication device 3, the mobile terminal 2000, etc.), etc.

The signal detection method performed by the micro controller unit MCU shown in FIG. 5 may include performing 1-point DFT based on the computation method described with reference to FIG. 10 to FIG. 17, and since the method is substantially the same as that described with reference to FIG. 10 to FIG. 17, detailed contents thereof will be omitted.

FIG. 19 illustrates a block diagram of an IoT device to which a wireless communication device according to an embodiment of the present disclosure is applied.

Referring to FIG. 19, IoT may refer to a network between things using wired/wireless communication. IoT devices have an accessible wired or wireless interface and may include devices that transmit or receive data by communicating with at least one or more other devices through a wired or wireless interface. The accessible interfaces of IoT devices may include, for example, a wired local area network (LAN); a wireless local area network (WLAN) such as Wi-Fi; a wireless personal area network (WPAN) such as Bluetooth; a wireless universal serial bus (USB); a Zigbee; near-field communication (NFC); a radio-frequency identification (RFID); power line communication (PLC); and/or a modem communication interface that may be connected to a mobile cellular network such as 3G, LTE, 4G, and/or 5G. The Bluetooth interface may support Bluetooth low energy (BLE).

Specifically, an IoT device 1000 may include a communication interface (RADIO Transceiver/Receiver) 1200 for communicating with the outside. The communication interface 1200 may be, for example, a wireless local area network such as a wired local area network (LAN), Bluetooth, Wi-fi, or Zigbee, or a modem communication interface capable of accessing a mobile cellular network such as PLC or 3G, LTE, 4G, or 5G. The communication interface 1200 may include a transmitter and/or a receiver. The IoT device 1000 may transmit and/or receive information from an access point or gateway through the transmitter and/or the receiver. In addition, the IoT device 1000 may communicate with a user device or other IoT device to transmit and/or receive control information or data of the IoT device 1000.

At least one of the wireless communication devices 1 and/or 2, and/or the communication device 3, described above with reference to FIG. 1 to FIG. 18 may be implemented in the communication interface 1200.

The IoT device 1000 may further include a processor that performs a computation or an application processor (AP) 1100. In addition, the IoT device 1000 may have a built-in battery for internal power supply or may further include a power supply unit that receives power from an external source. In addition, the IoT device 1000 may include a display (Display) 1400 for displaying an internal state or data. The user may control the IoT device 1000 through a user interface (UI) of the display 1400 of the IoT device 1000. The IoT device 1000 may transmit an internal state and/or data to the outside through the transmitter and receive a control command and/or data from the outside through the receiver.

The memory (Memory) 1300 may store a control command code, control data, or user data for controlling the IoT device 1000. The memory 1300 may include at least one of a volatile memory and a non-volatile memory. The non-volatile memory may include at least one of various memories such as a read only memory (ROM), a programmable ROM (PROM), an electrically programmable ROM (EPROM)), an electrically erasable and programmable ROM (EEPROM), a flash memory, a phase-change RAM (PRAM), and a magnetic RAM (MRAM), a resistive RAM (ReRAM), a ferroelectric RAM (FRAM), etc. The volatile memory may include at least one of various memories such as a dynamic RAM (DRAM), a static RAM (SRAM), a synchronous DRAM (SDRAM), etc.

The IoT device 1000 may further include a storage device. The storage device may include at least one of non-volatile media such as a hard disk (HDD), a solid state drive (SSD), embedded multi Media card (eMMC), a universal flash storage (UFS), etc. The storage device may store user information provided through the input/output unit (I/O) 1500 and sensing information collected through the sensor 1600.

FIG. 20 illustrates a block diagram of a mobile terminal to which a wireless communication device according to an embodiment of the present disclosure is applied.

Referring to FIG. 20, a mobile terminal 2000 may include an application processor 2100 (hereinafter referred to as AP), a memory 2200, a display 2300, and/or an RF module 2400. In addition, the mobile terminal 2000 may further include various components such as a lens, a sensor, an audio module, etc.

The AP 2100 may be implemented as a system-on-chip (SoC), and may include a central processing unit (CPU) 2110, a RAM 2120, a power management unit (PMU) 2130, a memory interface 2140, a display controller (DCON) 2150, a modem 2160, and/or a system bus 2170. Furthermore, the AP 2100 may further include various IPs. The AP 2100 may be referred to as a ModAP as functions of a modem chip are integrated therein.

The CPU 2110 may generally control the operations of the AP 2100 and the mobile terminal 2000. The CPU 2110 may control the operation of each component of the AP 2100. In addition, the CPU 2110 may be implemented as a multi-core. The multi-core is one computing component having two or more independent cores.

The RAM 2120 may temporarily store programs, data, or instructions. For example, programs and/or data stored in the memory 2200 may be temporarily stored in the RAM 2120 according to the control or booting code of the CPU 2110. The RAM 2120 may be implemented as a DRAM or an SRAM.

The PMU 2130 may manage power of each component of the AP 2100. The PMU 2130 may also determine an operation state of each component of the AP 2100 and control an operation thereof.

The memory interface 2140 may control the overall operation of the memory 2200 and control data exchange between each component of the AP 2100 and the memory 2200. The memory interface 2140 may write data to or read data from the memory 2200 according to a request from the CPU 2110.

The display controller 2150 may transmit image data to be displayed on the display 2300 to the display 2300. The display 2300 may be implemented as a flat panel display or a flexible display such as a liquid crystal display (LCD), an organic light emitting diode (OLED), or the like.

For wireless communication, the modem 2160 may modulate data to be transmitted to be suitable for the wireless environment and recover received data. The modem 2160 may perform digital-communication with the RF module 2410.

For reference, the modem 100 (and/or the modem 100) described above with reference to FIG. 1 to FIG. 3 may be implemented in the modem 2160.

The RF module 2410 may convert a higher frequency signal received through an antenna into a lower frequency signal and transmit the converted lower frequency signal to the modem 2160. In addition, the RF module 2410 may convert a lower frequency signal received from the modem 2160 into a higher frequency signal and transmit the converted higher frequency signal to the outside of the mobile terminal 2000 through an antenna. In addition, the RF module 2410 may amplify or filter signals.

For reference, the RFIC 200 (and/or the RFIC 200), the power modulator 300, the power amplifier PA, the duplexer 400, and the antenna ANT described above with reference to FIG. 1 to FIG. 18 may be implemented in the RF module 2410.

For this reason, in the mobile terminal 2000, broadband communication is possible while power consumption for communication may be reduced.

Conventional devices and methods for performing a built in self test (BIST) involve computation of discrete Fourier transforms including multiplications between data in floating point form and sampled data. However, such multiplications involve excessive overflow errors with respect to registers storing the data in floating point form and/or the sampled data. Accordingly, the conventional devices and methods are unable to perform the BIST with sufficient reliability.

However, according to embodiment(s), improved devices and methods are provided for performing a BIST involving computation of discrete Fourier transforms. For example, the improved devices and methods may include dividing the data in floating point form, and/or the sampled data, to obtain smaller sets of data (e.g., in separate, additional registers). Accordingly, multiplications between the data in floating point form and the sampled data may be performed without occurrence of (or with reduced occurrence of) overflow errors. Therefore, the improved devices and methods overcome the deficiencies of the conventional devices and methods to at least improve the reliability of the BIST.

According to an embodiment, operations described herein as being performed by the wireless communication device 1, the modem 100, the RFIC 200, the power modulator 300, the duplexer 400, the power amplifier PA, the digital transmission processing unit 110, the digital reception processing unit 120, each of the plurality of digital to analog converters DAC1 and DAC2, the analog to digital converter (ADC), the MIPI 130, the transmission circuit TXC, the reception circuit RXC, the local oscillator LO, the first analog baseband filter ABF1, the first mixer MX1, the amplifier 210, the second analog baseband filter ABF2, the second mixer MX2, the low-noise amplifier 220, the test logic TL, the crest factor reduction (CFR) 111, the shaping function (SF) 112, the digital pre-distortion (DPD) 113, the DELAY1 (114), the DELAY2 (115), the wireless communication device 2, the modem 100, the RFIC 200, the first digital transmission processing unit 110, the digital interface DI, the internal second digital transmission processing unit 205, the communication device 3, the transmission circuit 31, the reception circuit 33, the test logic 34, the signal sampler 341, the micro controller unit 343, the IoT device 1000, the communication interface 1200, the AP 1100, the I/O 1500, the sensor 1600, the mobile terminal 2000, the application processor 2100, the RF module 2400, the CPU 2110, the PMU 2130, the memory interface 2140, the display controller 2150, and/or the modem 2160 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiment(s) disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items. It will be understood that when an element is referred to as being “connected,” “coupled” or transmitted to another element, it may be directly connected, coupled or transmitted to the other element or intervening elements may be present.

While examples of the present disclosure have been described in connection with what are presently considered to be practical embodiment(s), it is to be understood that the disclosure is not limited thereto, but, on the contrary, is intended to cover various modifications and equivalent arrangements included within the spirit and scope of the appended claims.

What is claimed is:

1. A micro controller unit comprising:
a memory configured to store first data and second data, the first data being represented in a floating point form, and the second data being obtained by sampling a signal; and
processing circuitry configured to
generate (1_1)-th data by right-shifting the first data by a first bit,
generate a difference between the first data and the (1_1)-th data to obtain (1_2)-th data, and
perform 1-point discrete Fourier transform on the (1_1)-th data, the (1_2)-th data, and the second data based on a first function.

2. The micro controller unit of claim 1, wherein the processing circuitry is configured to:
multiply the (1_1)-th data and the second data to obtain a first product value;
multiply the (1_2)-th data and the second data to obtain a second product value; and
add the first product value and the second product value.

3. The micro controller unit of claim 1, wherein the processing circuitry is configured to:
generate (2_1)-th data by right-shifting the second data by a second bit; and
generate (2_2)-th data by right-shifting the second data by a third bit different from the second bit.

4. The micro controller unit of claim 3, wherein the processing circuitry is configured to:
multiply the (1_1)-th data and the (2-1)-th data to obtain a first product value;
multiply the (1_2)-th data and the (2-2)-th data to obtain a second product value; and
add the first product value and the second product value.

5. The micro controller unit of claim 3, wherein
a difference between bit digits of a floating point of the (1_1)-th data and a floating point of the (1_2)-th data is the same as a difference between the second bit and the third bit.

6. The micro controller unit of claim 3, wherein
the processing circuitry is configured to right-shift the second data by the second bit to generate (2_3)-th data, the (2_3)-th data including data lost from among the second data based on the right-shifting of the second data by the second bit.

7. The micro controller unit of claim 6, wherein the processing circuitry is configured to:
multiply the (1_1)-th data and the (2-1)-th data;
multiply the (1_1)-th data and the (2-3)-th data;
multiply the (1_2)-th data and the (2-1)-th data; and
multiply the (1_2)-th data and the (2-3)-th data.

8. The micro controller unit of claim 6, wherein
the processing circuitry is configured to right-shift the second data by the third bit to generate (2_4)-th data, the (2_4)-th data including data lost from among the second data based on the right-shifting of the second data by the third bit.

9. The micro controller unit of claim 8, wherein the processing circuitry is configured to:
multiply the (1_1)-th data and the (2-1)-th data;
multiply the (1_1)-th data and the (2-3)-th data;
multiply the (1_2)-th data and the (2-2)-th data; and
multiply the (1_2)-th data and the (2-4)-th data.

10. The micro controller unit of claim 1, wherein
the first function is a Goertzel algorithm.

11. The micro controller unit of claim 1, wherein
the memory includes a plurality of 32-bit registers.

12. The micro controller unit of claim 1, wherein
the processing circuitry is configured to determine the first data based on a frequency of the signal and a number of the second data.

13. A method of detecting a signal, comprising:
receiving a signal;
acquiring sampling data by sampling the signal;
acquiring first frequency data based on a frequency of the signal and a number of the sampling data, the first frequency data being represented in a floating point form;
generating second frequency data by right-shifting the first frequency data by a first bit;
generating a difference between the first frequency data and the second frequency data to obtain third frequency data; and
performing 1-point discrete Fourier transform on the second frequency data, the third frequency data, and the sampling data based on a first function.

14. The method of detecting the signal of claim 13, wherein the performing 1-point discrete Fourier transform includes:
multiplying the second frequency data and the sampling data to obtain a first product value;
multiplying the third frequency data and the sampling data to obtain a second product value; and
adding the first product value and the second product value.

15. The method of detecting the signal of claim 13, further comprising:
right-shifting the sampling data by a second bit to generate first shifted sampling data; and
right-shifting the sampling data by a third bit to generate second shifted sampling data, the third bit being different from the second bit.

16. The method of detecting the signal of claim 15, wherein the performing 1-point discrete Fourier transform includes:
multiplying the second frequency data and the first shifted sampling data to obtain a first product value;
multiplying the third frequency data and the second shifted sampling data to obtain a second product value; and
adding the first product value and the second product value.

17. The method of detecting the signal of claim 15, further comprising:
generating first loss data including data lost from among the sampling data based on the right-shifting the sampling data by the second bit; and
generating second loss data including data lost from among the sampling data based on the right-shifting the sampling data by the third bit.

18. The method of detecting the signal of claim 17, wherein the performing 1-point discrete Fourier transform includes:
multiplying the second frequency data and the first shifted sampling data;
multiplying the second frequency data and the first loss data;
multiplying the third frequency data and the first shifted sampling data; and
multiplying the third frequency data and the first loss data.

19. The method of detecting the signal of claim 17, wherein the performing 1-point discrete Fourier transform includes:
multiplying the second frequency data and the first shifted sampling data;
multiplying the second frequency data and the first loss data;
multiplying the third frequency data and the second shifted sampling data; and
multiplying the third frequency data and the second loss data.

20. A communication device comprising:
a transmission circuit;
a reception circuit;
a loop-back switch configured to selectively enable a built in self test mode, the built in self test mode including transmission of a signal from the transmission circuit to the reception circuit; and
processing circuitry configured to
receive the signal from the reception circuit to test the signal,
sample the signal to acquire sampling data,
acquire first frequency data based on a frequency of the signal and a number of
the sampling data, the first frequency data being represented in a floating point form,
generate second frequency data by right-shifting the first frequency data by a first bit,
generate a difference between the first frequency data and the second frequency data to obtain third frequency data, and
perform 1-point discrete Fourier transform on the second frequency data, the third frequency data, and the sampling data based on a first function.
